(19) United States
(12) Patent Application Publication
(10) Pub. No.: US 2020/0387969 A1
(43) Pub. Date: Dec. 10, 2020

(54) Systems and Methods for Volatility Tracking and Analysis

(71) Applicant: JPMorgan Chase Bank, N.A., New York, NY (US)

(72) Inventors: Du Li, London (GB); Moritz Duembgen, London (GB); Saul Doctor, London (GB); Danny White, London (GB)

(21) Appl. No.: 15/335,638

(22) Filed: Oct. 27, 2016

Related U.S. Application Data
(60) Provisional application No. 62/247,462, filed on Oct. 28, 2015.

(51) Int. Cl. G06Q 40/04

(52) U.S. Cl. CPC G06Q 40/04

(57) ABSTRACT

A method for estimating an expected volatility for financial instruments that are quoted in spread terms but which trade with an upfront and a fixed coupon may include a computer processor: (1) selecting a plurality of options, each option having a different option expiry; (2) for each option expiry, calculating a corresponding forward index level in a price term; (3) selecting a strike price for which an absolute difference between a receiver price and a payer price is smallest; (4) extracting and grouping a plurality of traded receivers having spread strike prices that are lower than the strike price, and payers having spread strike prices greater than the strike price; (5) calculating an expected strike price for each grouped option; (6) calculating an option notional for each of the plurality of options; (7) calculating a fixed expiry VTRAC-X volatility index; and (8) interpolating a fixed time-to-expiry VTRAC-X volatility index.

### RELATED APPLICATIONS

This application claims priority to U.S. Provisional Patent Application Ser. No. 62/247,462, filed Oct. 28, 2015, the disclosure of which is hereby incorporated by reference in its entirety.

### BACKGROUND OF THE INVENTION

### 1. Field of the Invention

The present invention generally relates to systems and methods for volatility tracking and analysis.

### 2. Description of the Related Art

Financial institutions attempt to forecast volatility—the variability in a financial asset—to determine the asset's riskiness. The greater the financial asset's volatility, the more its price fluctuates, implying a greater chance of large losses (or gains). Volatility plays a crucial role in a variety of contexts, including portfolio allocation, risk management, performance measurement, transaction costs and derivatives pricing.

As an asset in its own right, volatility therefore constitutes a suitable hedge on the one hand, and an attractive speculative instrument on the other hand, in particular due to its mean-reverting nature.

### SUMMARY OF THE INVENTION

Systems and methods for volatility tracking and analysis are disclosed. In one embodiment, a method for estimating an expected volatility for financial instruments that are quoted in spread terms but which trade with an upfront and a fixed coupon may include (1) a computer processor selecting a plurality of options, each option having a different option expiry; (2) for each option expiry, the computer processor calculating a corresponding forward index level in a price term; (3) the computer processor selecting a strike price for which an absolute difference between a receiver price and a payer price is smallest; (4) the computer processor extracting and grouping a plurality of traded receivers having spread strike prices that are lower than the strike price, and payers having spread strike prices greater than the strike price; (5) the computer processor calculating an expected strike price for each grouped option; (6) the computer processor calculating an option notional for each of the plurality of options; (7) the computer processor calculating a fixed expiry VTRAC-X volatility index; and (8) the computer processor interpolating a fixed time-to-expiry VTRAC-X volatility index.

According to one embodiment, the financial instrument may include a credit default swap, a credit default swap index, etc.

In one embodiment, the corresponding forward may be calculated by: the equation F=SpotPrice−Coupon·TtE; where TtE=DC(today, expiry)/360 stands for the day count fraction of the time to expiry under an ACT/360 convention.

In one embodiment, the step of calculating an option notional for each option may include assigning each option a notional

$${N}_{i} = \frac{Δ {K}_{i}}{{K}_{i}^{2}} \cdot \frac{2}{{TtE}^{′}} ,$$

where Kᵢ denotes the strike of the option in price terms and ΔKᵢ denotes the distance between the two neighboring strikes; and wherein

$$Δ {K}_{i} = \{ \begin{matrix}\frac{\vert {K}_{2} - {K}_{1} \vert}{2} at the center strike ( i = 1 ) , \\ \frac{\vert {K}_{i + 1} - {K}_{i - 1} \vert}{2} in between ( 1 < i < n ) , \\ \vert {K}_{n} - {K}_{n - 1} \vert at the last strike ( i = n ) .\end{matrix}$$

In one embodiment, the fixed expiry VTRAC-X volatility index may be calculated according to the following equation:

$$VTRAC \text{-} X Bid = \sqrt{ImpliedVariance ( Bid )} = \sqrt{\sum OptionBidPrices - Adjustment} = \sqrt{{\sum }_{i} \frac{Δ {K}_{i}}{{K}_{i}^{2}} \cdot \frac{2}{TtE} \cdot BidPrice ( {K}_{i} ) - \frac{1}{TtE} {( \frac{F}{{K}_{0}} - 1 )}^{2}} .$$

In one embodiment, the fixed time-to-expiry VTRAC-X volatility index may be calculated using the following equation:

$$VTRAC \text{-} {X}_{1 m} = \sqrt{\begin{matrix}VTRAC \text{-} {X}_{{1}^{st}}^{2} \cdot \frac{DC ( {T}_{0} , {1}^{s t} )}{D C ( {T}_{0} , 1 m )} + VTRAC \text{-} {X}_{{1}^{st} , {2}^{nd}}^{2} \cdot \\ \frac{DC ( {1}^{st} , 1 m )}{DC ( {t}_{0} , 1 m )}\end{matrix}} = \sqrt{\begin{matrix}VTRAC \text{-} {X}_{{1}^{st}}^{2} \frac{DC ( {t}_{0} , {1}^{st} ) DC ( 1 m , {2}^{nd} )}{DC ( {t}_{0} , 1 m ) DC ( {1}^{st} , {2}^{nd} )} + \\ VTRAC \text{-} {X}_{{2}^{nd}}^{2} \frac{DC ( {t}_{0} , {2}^{nd} ) DC ( {1}^{st} , 1 m )}{DC ( {t}_{0} , 1 m ) DC ( {1}^{st} , {2}^{nd} )}\end{matrix} .}$$

According to another embodiment, a method of estimating an expected volatility for financial instruments that are quoted in spread terms but which trade with an upfront and a fixed coupon may include (1) a computer processor selecting a plurality of options, each option having a different option expiry; (2) for each option expiry, the computer processor calculating a corresponding forward index level in a price term; (3) the computer processor selecting a strike price for which an absolute difference between a receiver price and a payer price is smallest; (4) the computer processor extracting and grouping a plurality of traded receivers having spread strike prices that are lower than the strike price, and payers having spread strike prices greater than the strike price; (5) the computer processor calculating an expected strike price for each grouped option; (6) the computer processor calculating an option notional for each of the plurality of options; (7) the computer processor calculating a delta hedge that corresponds to the grouped traded and payers; and (8) the computer processor calculating a total return.

According to one embodiment, the financial instrument may include a credit default swap, a credit default swap index, etc.

In one embodiment, the corresponding forward may be calculated by: the equation F=SpotPrice−Coupon·TtE; where TtE=DC(today, expiry)/360 stands for the day count fraction of the time to expiry under an ACT/360 convention.

In one embodiment, the step of calculating an option notional for each option may include assigning each option a notional

$${N}_{i} = \frac{Δ {K}_{i}}{{K}_{i}^{2}} \cdot \frac{2}{{TtE}^{′}} ,$$

where Kᵢ denotes the strike of the option in price terms and ΔKᵢ denotes the distance between the two neighboring strikes; and wherein

$$Δ {K}_{i} = \{ \begin{matrix}\frac{\vert {K}_{2} - {K}_{1} \vert}{2} at the center strike ( i = 1 ) , \\ \frac{\vert {K}_{i + 1} - {K}_{i - 1} \vert}{2} in between ( 1 < i < n ) , \\ \vert {K}_{n} - {K}_{n - 1} \vert at the last strike ( i = n ) .\end{matrix}$$

In one embodiment, the fixed expiry VTRAC-X volatility index may be calculated according to the following equation:

$$VTRAC \text{-} X Bid = \sqrt{ImpliedVariance ( Bid )} = \sqrt{\sum OptionBidPrices - Adjustment} = \sqrt{{\sum }_{i} \frac{Δ {K}_{i}}{{K}_{i}^{2}} \cdot \frac{2}{TtE} \cdot BidPrice ( {K}_{i} ) - \frac{1}{TtE} {( \frac{F}{{K}_{0}} - 1 )}^{2}} .$$

In one embodiment, the fixed time-to-expiry VTRAC-X volatility index may be calculated using the following equation:

$$VTRAC \text{-} {X}_{1 m} = \sqrt{\begin{matrix}VTRAC \text{-} {X}_{{1}^{st}}^{2} \cdot \frac{DC ( {T}_{0} , {1}^{s t} )}{D C ( {T}_{0} , 1 m )} + VTRAC \text{-} {X}_{{1}^{st} , {2}^{nd}}^{2} \cdot \\ \frac{DC ( {1}^{st} , 1 m )}{DC ( {t}_{0} , 1 m )}\end{matrix}} = \sqrt{\begin{matrix}VTRAC \text{-} {X}_{{1}^{st}}^{2} \frac{DC ( {t}_{0} , {1}^{st} ) DC ( 1 m , {2}^{nd} )}{DC ( {t}_{0} , 1 m ) DC ( {1}^{st} , {2}^{nd} )} + \\ VTRAC \text{-} {X}_{{2}^{nd}}^{2} \frac{DC ( {t}_{0} , {2}^{nd} ) DC ( {1}^{st} , 1 m )}{DC ( {t}_{0} , 1 m ) DC ( {1}^{st} , {2}^{nd} )}\end{matrix} .}$$

According to another embodiment, a system for estimating an expected volatility for financial instruments that are quoted in spread terms but which trade with an upfront and a fixed coupon may include at least one market platform; at least one of a bank system, a trading system, and a publishing system; and a server comprising at least one computer processor. The server may perform the following: select a plurality of options from the at least one market platform, each option having a different option expiry; calculate a corresponding forward index level in a price term; select a strike price for which an absolute difference between a receiver price and a payer price is smallest; extract and group a plurality of traded receivers having spread strike prices that are lower than the strike price, and payers having spread strike prices greater than the strike price; calculate an expected strike price for each grouped option; calculate an option notional for each of the plurality of options; calculate a fixed expiry VTRAC-X volatility index; interpolate a fixed time-to-expiry VTRAC-X volatility index; and output the fixed time-to-expiry VTRAC-X volatility index to at least one of the a bank system, a trading system, and a publishing system.

According to one embodiment, the financial instrument may include a credit default swap, a credit default swap index, etc.

In one embodiment, the corresponding forward may be calculated by: the equation F=SpotPrice−Coupon·TtE; where TtE=DC(today, expiry)/360 stands for the day count fraction of the time to expiry under an ACT/360 convention.

In one embodiment, the step of calculating an option notional for each option may include assigning each option a notional

$${N}_{i} = \frac{Δ {K}_{i}}{{K}_{i}^{2}} \cdot \frac{2}{{TtE}^{′}} ,$$

where Kᵢ denotes the strike of the option in price terms and ΔKᵢ denotes the distance between the two neighboring strikes; and wherein

$$Δ {K}_{i} = \{ \begin{matrix}\frac{\vert {K}_{2} - {K}_{1} \vert}{2} at the center strike ( i = 1 ) , \\ \frac{\vert {K}_{i + 1} - {K}_{i - 1} \vert}{2} in between ( 1 < i < n ) , \\ \vert {K}_{n} - {K}_{n - 1} \vert at the last strike ( i = n ) .\end{matrix}$$

In one embodiment, the fixed expiry VTRAC-X volatility index may be calculated according to the following equation:

$$VTRAC \text{-} X Bid = \sqrt{ImpliedVariance ( Bid )} = \sqrt{\sum OptionBidPrices - Adjustment} = \sqrt{{\sum }_{i} \frac{Δ {K}_{i}}{{K}_{i}^{2}} \cdot \frac{2}{TtE} \cdot BidPrice ( {K}_{i} ) - \frac{1}{TtE} {( \frac{F}{{K}_{0}} - 1 )}^{2}} .$$

In one embodiment, the fixed time-to-expiry VTRAC-X volatility index may be calculated using the following equation:

$$VTRAC \text{-} {X}_{1 m} = \sqrt{\begin{matrix}VTRAC \text{-} {X}_{{1}^{st}}^{2} \cdot \frac{DC ( {T}_{0} , {1}^{s t} )}{D C ( {T}_{0} , 1 m )} + VTRAC \text{-} {X}_{{1}^{st} , {2}^{nd}}^{2} \cdot \\ \frac{DC ( {1}^{st} , 1 m )}{DC ( {t}_{0} , 1 m )}\end{matrix}} = \sqrt{\begin{matrix}VTRAC \text{-} {X}_{{1}^{st}}^{2} \frac{DC ( {t}_{0} , {1}^{st} ) DC ( 1 m , {2}^{nd} )}{DC ( {t}_{0} , 1 m ) DC ( {1}^{st} , {2}^{nd} )} + \\ VTRAC \text{-} {X}_{{2}^{nd}}^{2} \frac{DC ( {t}_{0} , {2}^{nd} ) DC ( {1}^{st} , 1 m )}{DC ( {t}_{0} , 1 m ) DC ( {1}^{st} , {2}^{nd} )}\end{matrix} .}$$

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for volatility tracking and analysis according to one embodiment;

FIG. 2 depicts a method for volatility tracking according to one embodiment; and

FIG. 3 depicts a method for trading credit variance according to one embodiment.

### DETAILED DESCRIPTION OF PREFERRED EMBODIMENTS

Embodiments disclosed herein are directed to systems and methods for volatility tracking and analysis.

Many credit products, such as credit indices, are typically quoted in spread terms with a fixed coupon being the standard approach of other asset classes' model-free measurement of implied volatility invalid. While spread volatility is well suited to compare volatility across indices, it can yield a misleading picture in a historical context.

Implied volatility may be found by solving for the spread volatility in Black's formula to achieve a given option's market price. Repeating this over all traded strikes and expiries gives rise to the well-known implied volatility surface. At-the-money implied volatility is often treated as the market-implied forecast of future realized volatility, but there are several problems with this interpretation. For example, it ignores the skew of the volatility surface as the market's outlook on future volatility is reflected through the entirety of the implied volatility surface. At-the-money volatility constitutes only a single point and is therefore an incomplete and inaccurate representation. It also is not tradeable. One may attempt to capture the differential between at-the-money and realized volatility by e.g. delta-hedging an at-the-money option, but the highly non-constant Gamma profile of an individual option means that the tracking is generally quite poor. It is also model-dependent as it is, by definition, a model-dependent quantity, derived within the log-normal world of Black's formula.

Embodiments disclosed herein relate to a model-independent methodology, referred to as “VTRAC-X,” to measure market-implied volatility in markets that feature either an upfront payment based on spread quotation of the underlying product, or notional reductions and loss adjustments based on documented credit event. VTRAC-X represents a transparent, model-independent tracker of expected credit volatility and its term structure.

In embodiments, an option basket that comprises out-of-the-money options for all traded strikes having a given expiry may be constructed. The notional of each option may be chosen such that the basket's Gamma profile is constant through time and space and VTRAC-X² (squared for variance) results as the centered basket price.

In contrast to the shortcomings of implied volatility, in embodiments, because VTRAC-X may be obtained from a basket that contains all traded options, it reflects the entire volatility surface. It is also tradeable, as the same option basket that underlies the definition of VTRAC-X may be used to trade it. Together with a delta-hedging index strategy, one is exposed to VTRAC-X² versus realized variance. The option basket and the index strategy are the two constituent legs of VTRAC-X Swaps. VTRAX-X is also model independent. VTRAC-X does not depend on any parametric model assumptions, similar to backing out the implied probability distribution of an asset directly from option prices.

In one embodiment, VTRAC-X may be defined as follows:

$$VTRAC \text{-} {X}^{2} = \frac{2}{T} {\sum }_{i} \frac{Δ {K}_{i}}{{K}_{i}^{2}} Q ( {K}_{i} ) - \frac{1}{T} {( \frac{F}{{K}_{0}} - 1 )}^{2}$$

where:

T is the time to expiry;

F is the forward (price-quoted);

K₀ is a centering strike (price-quoted);

Kᵢ is the strike price of the ith out-of-the-money option; a payer option if Kᵢ<K₀; both payer and receiver if Kᵢ=K₀;

ΔKᵢ is the interval between strike prices—half the difference between the strike on either side of Kᵢ; and

Q(Kᵢ) is the mid-price for each option with strike Kᵢ.

In general, spread quotes may be converted into price-equivalents, and these prices may be adjusted for expected front-end losses and coupons. Based on the adjusted price quotes, a basket of tradeable options may be created. The value of the basket of options, together with a centering adjustment, yields implied price variance and volatility.

In one embodiment, a conversion to link implied price variance/volatility to implied spread variance/volatility may be provided.

Credit events may impact the measurement of implied volatility.

Because embodiments are model independent, they do not rely on parametric assumptions of the underlying for its validity. Thus, the calculation of implied volatility may rely on market-quoted option prices, repeated use of the standard market convention to convert between quoted spreads and upfront prices (e.g., the ISDA standard model v1), contract details of the underlying index (coupon level, scaling factor, accrued losses, and expiry date), and basic arithmetic.

The resulting implied volatility may be replicated through a basket of options and a deterministic strategy in the underlying.

In one embodiment, VTRAC-X Swaps allows investors to accurately trade credit volatility through a simple product. In general, trading a pure view on credit volatility has been difficult and inaccurate, as approaches like delta-hedging straddles suffer from imprecision, inconvenience and do not take the typically rich skew of the volatility surface into account. VTRAC-X Swaps allows investors to trade pure credit variance through a single trade.

Expected future spread volatility from VTRAC-X may be determined by simple scaling, similar to converting between realized price and spread volatility: For example:

$$VTRAC \text{-} X Sprd = VTRAC \text{-} X \cdot \frac{P}{D \cdot S}$$

where S, P and D represent spread, price and duration, respectively.

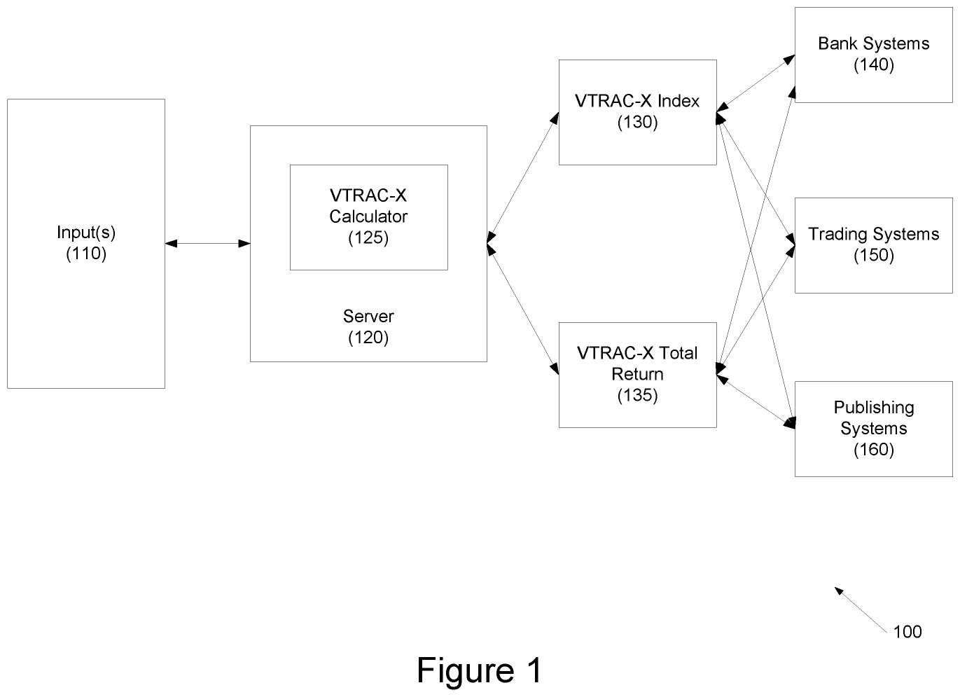

Referring to FIG. 1, a system for volatility tracking and analysis is disclosed according to one embodiment. System 100 may include input(s) 110, server 120 that may host VTRAC-X calculator 125, outputs VTRAC-X Index 130 and VTRAC-X Total Return 135, bank systems 140, trading systems 150, and publishing systems 160.

In one embodiment, input(s) 110 may include contractual details of the underlying instruments, market quotes of underlying instruments and options, etc. Data source(s) for the inputs may include market platforms (e.g., dealer screens/emails) for quoting underlying instruments and options, etc. Other inputs and/or sources may be used as necessary and/or desired.

In one embodiment, bank systems 140 may automatically exchange money or execute a predefined financial action in response to VTRAC-X Index 130 and/or VTRAC-X Total Returns 135. Trading systems 150 may automatically execute a trade or execute a predefined action in response to VTRAC-X Index 130 and/or VTRAC-X Total Returns 135. Publication systems 160 may publish VTRAC-X Index 130 and/or VTRAC-X Total Returns 135.

Other systems may be included as necessary and/or desired.

In one embodiment, VTRAC-X Index 130 and/or VTRAC-X Total Returns 135 may be written to a dependent ledger, such as a Blockchain-based ledger (not shown).

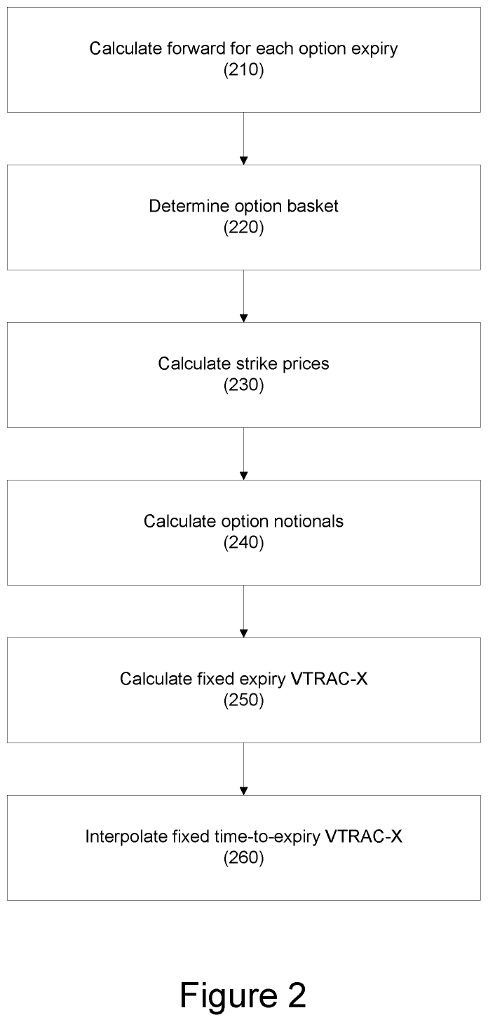

Referring to FIG. 2, a method for volatility tracking is disclosed according to one embodiment. In step 210, for each option expiry, the corresponding forward in price terms is calculated.

F=SpotPrice−Coupon·TtE

where TtE=DC(today, expiry)/360 stands for the day count fraction of the time to expiry under an ACT/360 convention. For a spread-quoted index, SpotPrice may be obtained by converting the index spread into its equivalent price quote via the official ISDA Standard Model v1. Bloomberg's CDSW page provides an implementation of the model.

In step 220, the options basket may be determined. For example, the strike K₀ for which the absolute difference in raids between receiver and payer price is smallest is picked, and the traded receivers with spread strikes lower than K₀ and all payers with spread strikes greater than K₀ may be grouped into a “basket.”

In step 230, the strike prices may be calculated. In one embodiment, if the option strikes are spread-quoted, the spread strikes may be converted to the expected strike price at expiry for each option using, for example, the official ISDA CDS Standard Model v1. In one embodiment, Bloomberg's CDSW page may be used to verify the results.

In step 240, the option notionals may be calculated. In one embodiment, this may yield a constant gamma across the basket of options. Starting with the payer options, enumerate the strikes from the center outwards up to the last, nth strike. Assign each option the notional

$${N}_{i} = \frac{Δ {K}_{i}}{{K}_{i}^{2}} \cdot \frac{2}{{TtE}^{′}}$$

where Kᵢ denotes the strike of the option in price terms and ΔKᵢ denotes the distance between the two neighboring strikes (in price terms) whereby

$$Δ {K}_{i} = \{ \begin{matrix}\frac{\vert {K}_{2} - {K}_{1} \vert}{2} at the center strike ( i = 1 ) , \\ \frac{\vert {K}_{i + 1} - {K}_{i - 1} \vert}{2} in between ( 1 < i < n ) , \\ \vert {K}_{n} - {K}_{n - 1} \vert at the last strike ( i = n ) .\end{matrix}$$

This may be repeated, step-by-step, for the receiver options.

In step 250, the fixed expiry VTRAC-X index may be calculated. In one embodiment, the sum of the weighted options minus a centering adjustment may yield the implied price variance up to expiry and VTRAC-X (for this expiry) follows as its square root.

$$VTRAC \text{-} X Bid = \sqrt{ImpliedVariance ( Bid )} = \sqrt{\sum OptionBidPrices - Adjustment} = \sqrt{{\sum }_{i} \frac{Δ {K}_{i}}{{K}_{i}^{2}} \cdot \frac{2}{TtE} \cdot BidPrice ( {K}_{i} ) - \frac{1}{TtE} {( \frac{F}{{K}_{0}} - 1 )}^{2}} .$$

By substituting the options' ask prices, VTRAC-X Ask may be calculated. For example,

$$VTRAC \text{-} X Bid = \sqrt{0.043660 \% - \frac{1}{0.172 \; 2} {( \frac{101.134}{101.124} - 1 )}^{2}} = \sqrt{0.043656 \%} = 2.089 \% , \\ VTRAC \text{-} X Ask = \sqrt{0.051149 \% - \frac{1}{0.1722} {( \frac{101.134}{101.124} - 1 )}^{2}} = \sqrt{0.051145 \%} = 2.261 \% ,$$

and the VTRAC-X Mid follows as the weighted average

$$VTRAC \text{-} X Mid = \sqrt{\frac{VTRAC \text{-} X {Bid}^{2} + VTRAC \text{-} X {Ask}^{2}}{2}} = 2.177 \% .$$

In terms of spread volatility, since VTRAC-X Sprd=VTRAC-X·

$$\frac{P}{D \cdot S} \text{:}$$

VTRAC-X Sprd Bid,Mid,Ask=(62.9%,65.54%,68.08%)

VTRAC-X Sprd comes out significantly higher than the quoted ATM implied volatility of 63%.

In step 260, the fixed time-to-expiry VTRAC-X may be interpolated. In one embodiment, a term structure of VTRAC-X for traded expiries is determined. This may be denoted by VTRACX₁_{^{st}}, VTRACX₂_{^{nd}} the VTRAC-X Mids for the 1^{st} and 2^{11d} expiry and by VTRACX₁_{^{st}}_{,2}_{^{nd}} the corresponding forward volatility.

The fixed time to maturity index VTRAC-X₁ₘ may be associated with 30 calendar days of volatility, so that its value is interpolated from the traded expiries by adding variances

$$V T RAC \text{-} {X}_{1 m} = \sqrt{\begin{matrix}VTRAC \text{-} {X}_{{1}^{st}}^{2} \cdot \frac{DC ( {T}_{0} , {1}^{s t} )}{D C ( {T}_{0} , 1 m )} + VTRAC \text{-} {X}_{{1}^{st} , {2}^{nd}}^{2} \cdot \\ \frac{DC ( {1}^{st} , 1 m )}{DC ( {t}_{0} , 1 m )}\end{matrix}} = \sqrt{\begin{matrix}VTRAC \text{-} {X}_{{1}^{st}}^{2} \frac{DC ( {t}_{0} , {1}^{st} ) DC ( 1 m , {2}^{nd} )}{DC ( {t}_{0} , 1 m ) DC ( {1}^{st} , {2}^{nd} )} + \\ VTRAC \text{-} {X}_{{2}^{nd}}^{2} \frac{DC ( {t}_{0} , {2}^{nd} ) DC ( {1}^{st} , 1 m )}{DC ( {t}_{0} , 1 m ) DC ( {1}^{st} , {2}^{nd} )}\end{matrix} .}$$

In equivalent fashion VT RAC-X₂ₘ, VTRAC-X₃ₘ, are found from their enclosing expiries.

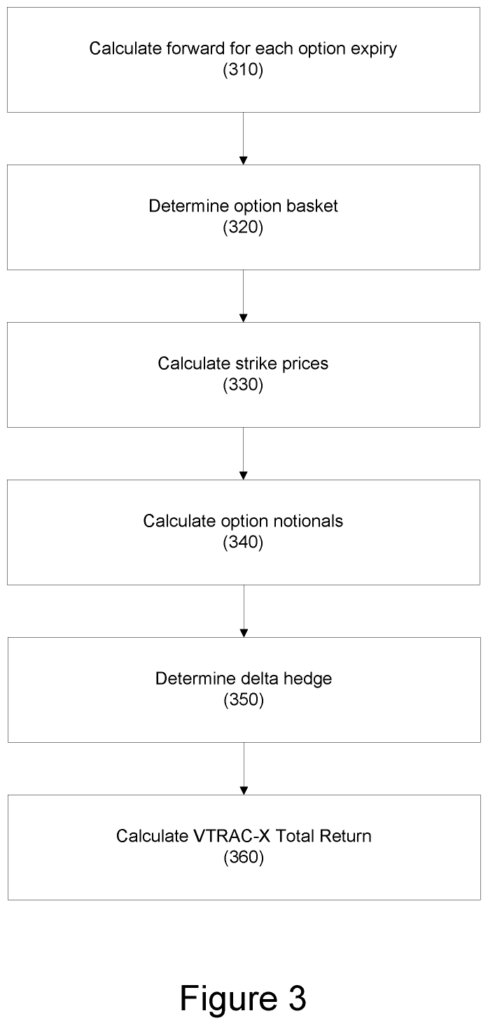

Referring to FIG. 3, a method for trading credit variance is disclosed according to one embodiment.

In one embodiment, VTRAC-X Swaps allow investors to take a view on implied versus realized variance in credit markets through a single transaction. Each VTRAC-X Swap may consist of two legs, a static option basket, reflecting VTRAC-X, and the total return of a dynamic index strategy that captures the delta of the VTRAC-X basket. VTRAC-X Swap trades may be sized to target an exposure in variance, volatility or daily breakevens. The mark-to-market of VTRAC-X Swaps may closely track the difference of realized and implied variance both on a trade-by-trade basis and through a historical backtest.

In step 310, for each option expiry, the corresponding forward in price terms is calculated. This may be similar to step 210, above.

In step 320, the options basket may be determined. This may be similar to step 320, above.

In step 330, the strike prices may be calculated. This may be similar to step 330, above.

In step 340, the option notionals may be calculated. This may be similar to step 240, above.

In step 350, a delta hedge that corresponds to the option basket may be determined. In one embodiment, the rebalancing rule may be given by an intuitive formula and the total return of the strategy is cash-settled at expiry of the trade.

For the buyer of a VTRAC-X Swap (the buyer of options), the index strategy rebalances at the end of each day to a position of Deltaₜ in index protection with

$${Delta}_{t} = Delta ( {F}_{t} ) = ( \frac{1}{K} - \frac{1}{{F}_{t}} ) \cdot 2 \cdot ContractScaling$$

where Fₜ=SpotPriceₜ−Coupon·DC (t, T)/360 and denotes the forward of the index in price terms, K denotes the centering strike in price terms, and “ContractScaling” denotes a constant contract scaling factor that aligns the size of the index with the option basket. Delta is purely a function of the forward price level. Apart from this dependence on the forward, the Delta profile is constant in time.

In step 360, the total return is calculated. In one embodiment, the total return calculation for the delta strategy may follow a widely adopted approach, with a long and a short VTRAC-X Delta TRS strategy, corresponding to a Long or Short position in a VTRAC-X Swap. The two are symmetrical apart from the transaction costs that arise due to rebalancing.

In one embodiment, DeltaTRSₜ may denote the evolution of the VTRAC-X Delta TRS index corresponding to a long position in a VTRAC-X Swap:

$${DeltaTRS}_{t} = {DeltaTRS}_{t - 1} \cdot ( 1 + {Return}_{t} )$$

$$with$$

$${Return}_{t} = + {Delta}_{t - 1} \cdot ( \frac{I d x R e {t}_{t}}{I d x R e {t}_{t - 1}} - 1 ) - R \cdot \vert {Delta}_{t} - {Delta}_{t - 1} \vert$$

and IdxRetₜ may denotes the end-of-day level of the total return time series of the underlying index.

For the VTRAC-X Delta TRS index corresponding to a short position in a VTRAC-X Swap, the return may be calculated from a negative Delta while costs still apply:

$${ShortReturn}_{t} = - {Delta}_{t - 1} \cdot ( \frac{I d x R e {t}_{t}}{I d x R e {t}_{t - 1}} - 1 ) - R \cdot \vert {Delta}_{t} - {Delta}_{t - 1} \vert .$$

R represents the transaction cost that is deducted from the returns per unit of notional that gets rebalanced.

The following documents are hereby incorporated by reference, in their entireties: U.S. Patent Application Publication No. 2005/0102214; U.S. Patent Application Publication No. 2015/0039532; U.S. Patent Application Publication No. 2014/0040092; U.S. Patent Application Publication No. 2014/0052599; U.S. Patent Application Publication No. 2015/0039532; and Yang, Zhaoyang and Dobrek, Lukasz Maciej, Mark-to-Market Credit Index Option Pricing and Credit Volatility Index (Jun. 23, 2015).

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method of estimating an expected volatility for financial instruments that are quoted in spread terms but which trade with an upfront and a fixed coupon, comprising:
in an information processing apparatus comprising at least one computer processor:
selecting a plurality of options, each option having a different option expiry;
for each option expiry, calculating a corresponding forward index level in a price term;
selecting a strike price for which an absolute difference between a receiver price and a payer price is smallest;
extracting and grouping a plurality of traded receivers having spread strike prices that are lower than the strike price, and payers having spread strike prices greater than the strike price;
calculating an expected strike price for each grouped option;
calculating an option notional for each of the plurality of options;
calculating a first fixed expiry VTRAC-X volatility index for a first expiry;
calculating a second fixed expiry VTRAC-X volatility index for a second expiry;
interpolating a third fixed time-to-expiry VTRAC-X volatility index for a third expiry based on the VTRAC-X volatility indices for the first and second expiries; and
outputting a control signal comprising the third fixed time-to-expiry VTRAC-X volatility index for the third expiry to at least one of a bank system, a trading system, and a publishing system, wherein in response to the control signal, the bank system automatically executes a predefined financial action, the trading system automatically executes a trade, and the publishing system automatically publishes the third fixed time-to-expiry VTRAC-X volatility index;
wherein the first and second fixed expiry VTRAC-X volatility indices are calculated according to the following equation:
$$VTRAC \text{-} X Bid = \sqrt{ImpliedVariance ( Bid )} = \sqrt{\sum OptionBidPrices - Adjustment} = \sqrt{{\sum }_{i} \frac{Δ {K}_{i}}{{K}_{i}^{2}} \cdot \frac{2}{TtE} \cdot BidPrice ( {K}_{i} ) - \frac{1}{TtE} {( \frac{F}{{K}_{0}} - 1 )}^{2}}$$
and
wherein the third fixed time-to-expiry VTRAC-X volatility index is interpolated using the following equation:
$$VTRAC \text{-} {X}_{1 m} = \sqrt{\begin{matrix}VTRAC \text{-} {X}_{{1}^{st}}^{2} \cdot \frac{DC ( {T}_{0} , {1}^{s t} )}{D C ( {T}_{0} , 1 m )} + VTRAC \text{-} {X}_{{1}^{st} , {2}^{nd}}^{2} \cdot \\ \frac{DC ( {1}^{st} , 1 m )}{DC ( {t}_{0} , 1 m )}\end{matrix}} = \sqrt{\begin{matrix}VTRAC \text{-} {X}_{{1}^{st}}^{2} \frac{DC ( {t}_{0} , {1}^{st} ) DC ( 1 m , {2}^{nd} )}{DC ( {t}_{0} , 1 m ) DC ( {1}^{st} , {2}^{nd} )} + \\ VTRAC \text{-} {X}_{{2}^{nd}}^{2} \frac{DC ( {t}_{0} , {2}^{nd} ) DC ( {1}^{st} , 1 m )}{DC ( {t}_{0} , 1 m ) DC ( {1}^{st} , {2}^{nd} )}\end{matrix} .}$$

2. The method of claim 1, wherein the financial instrument comprises a credit default swap.

3. The method of claim 1, wherein the financial instrument comprises a credit default swap index.

4. The method of claim 1, wherein the corresponding forward is calculated by:
F=SpotPrice−Coupon·TtE
where TtE=DC(today, expiry)/360 stands for the day count fraction of the time to expiry under an ACT/360 convention.

5. The method of claim 1, wherein calculating an option notional for each option comprises:
assigning each option a notional
$${N}_{i} = \frac{Δ {K}_{i}}{{K}_{i}^{2}} \cdot \frac{2}{{TtE}^{′}}$$
where Kᵢ denotes the strike of the option in price terms and ΔKᵢ denotes the distance between the two neighboring strikes;
wherein
$$Δ {K}_{i} = \{ \begin{matrix}\frac{\vert {K}_{2} - {K}_{1} \vert}{2} at the center strike ( i = 1 ) , \\ \frac{\vert {K}_{i + 1} - {K}_{i - 1} \vert}{2} in between ( 1 < i < n ) , \\ \vert {K}_{n} - {K}_{n - 1} \vert at the last strike ( i = n ) .\end{matrix}$$

6-7. (canceled)

8. A method of estimating an expected volatility for financial instruments that are quoted in spread terms but which trade with an upfront and a fixed coupon, comprising:
a computer processor selecting a plurality of options, each option having a different option expiry;
for each option expiry, the computer processor calculating a corresponding forward index level in a price term;
the computer processor selecting a strike price for which an absolute difference between a receiver price and a payer price is smallest;
the computer processor extracting and grouping a plurality of traded receivers having spread strike prices that are lower than the strike price, and payers having spread strike prices greater than the strike price;
the computer processor calculating an expected strike price for each grouped option;
the computer processor calculating an option notional for each of the plurality of options;
the computer processor automatically implementing a delta hedging strategy that corresponds to the grouped traded receivers and payers; and
the computer processor calculating a total return;
wherein implementing a delta hedging strategy comprises:
rebalancing at the end of each day to a position of Deltaₜ in index protection with:
$${Delta}_{t} = Delta ( {F}_{t} ) = ( \frac{1}{K} - \frac{1}{{F}_{t}} ) \times 2 \times ContrastScaling$$
where Fₜ denotes the forward of the index in price terms,
K denotes the centering strike in price terms; and
ContractScaling denotes a constant contract scaling factor that aligns the size of the index with the option basket.

9. The method of claim 8, wherein the financial instrument comprises a credit default swap.

10. The method of claim 8, wherein the financial instrument comprises a credit default swap index.

11. The method of claim 8, wherein the corresponding forward is calculated by:
F=SpotPrice−Coupon·TtE
where TtE=DC(today, expiry)/360 stands for the day count fraction of the time to expiry under an ACT/360 convention.

12. The method of claim 8, wherein calculating an option notional for each option comprises:
assigning each option a notional
$${N}_{i} = \frac{Δ {K}_{i}}{{K}_{i}^{2}} \cdot \frac{2}{{TtE}^{′}}$$
where Kᵢ denotes the strike of the option in price terms and ΔKᵢ denotes the distance between the two neighboring strikes;
wherein
$$Δ {K}_{i} = \{ \begin{matrix}\frac{\vert {K}_{2} - {K}_{1} \vert}{2} at the center strike ( i = 1 ) , \\ \frac{\vert {K}_{i + 1} - {K}_{i - 1} \vert}{2} in between ( 1 < i < n ) , \\ \vert {K}_{n} - {K}_{n - 1} \vert at the last strike ( i = n ) .\end{matrix}$$

13-14. (canceled)

15. A system for estimating an expected volatility for financial instruments that are quoted in spread terms but which trade with an upfront and a fixed coupon, comprising:
at least one market platform;
at least one of a bank system, a trading system, and a publishing system; and
a server comprising at least one computer processor that performs the following:
select a plurality of options from the at least one market platform, each option having a different option expiry;
calculate a corresponding forward index level in a price term;
select a strike price for which an absolute difference between a receiver price and a payer price is smallest;
extract and group a plurality of traded receivers having spread strike prices that are lower than the strike price, and payers having spread strike prices greater than the strike price;
calculate an expected strike price for each grouped option;
calculate an option notional for each of the plurality of options;
calculate a first fixed expiry VTRAC-X volatility index for a first expiry;
calculate a second fixed expiry VTRAC-X volatility index for a second expiry;
interpolate a third fixed time-to-expiry VTRAC-X volatility index for a third expiry based on the first fixed expiry VTRAC-X volatility index and the second fixed expiry VTRAC-X volatility index; and
output a control signal comprising the third fixed time-to-expiry VTRAC-X volatility index for the third expiry to at least one of the bank system, a trading system, and a publishing system, wherein in response to the control signal, the bank system automatically executes a predefined financial action, the trading system automatically executes a trade, and the publishing system automatically publishes the third fixed time-to-expiry VTRAC-X volatility index;
wherein the first and second fixed expiry VTRAC-X volatility indices are calculated according to the following equation:
$$VTRAC \text{-} X Bid = \sqrt{ImpliedVariance ( Bid )} = \sqrt{\sum OptionBidPrices - Adjustment} = \sqrt{{\sum }_{i} \frac{Δ {K}_{i}}{{K}_{i}^{2}} \cdot \frac{2}{TtE} \cdot BidPrice ( {K}_{i} ) - \frac{1}{TtE} {( \frac{F}{{K}_{0}} - 1 )}^{2}}$$
and
wherein the third fixed time-to-expiry VTRAC-X volatility index is interpolated using the following equation:
$$VTRAC \text{-} {X}_{1 m} = \sqrt{\begin{matrix}VTRAC \text{-} {X}_{{1}^{st}}^{2} \cdot \frac{DC ( {T}_{0} , {1}^{s t} )}{D C ( {T}_{0} , 1 m )} + VTRAC \text{-} {X}_{{1}^{st} , {2}^{nd}}^{2} \cdot \\ \frac{DC ( {1}^{st} , 1 m )}{DC ( {t}_{0} , 1 m )}\end{matrix}} = \sqrt{\begin{matrix}VTRAC \text{-} {X}_{{1}^{st}}^{2} \frac{DC ( {t}_{0} , {1}^{st} ) DC ( 1 m , {2}^{nd} )}{DC ( {t}_{0} , 1 m ) DC ( {1}^{st} , {2}^{nd} )} + \\ VTRAC \text{-} {X}_{{2}^{nd}}^{2} \frac{DC ( {t}_{0} , {2}^{nd} ) DC ( {1}^{st} , 1 m )}{DC ( {t}_{0} , 1 m ) DC ( {1}^{st} , {2}^{nd} )}\end{matrix} .}$$

16. The system of claim 15, wherein the financial instrument comprises one of a credit default swap and a credit default swap index.

17. The system of claim 15, wherein the corresponding forward is calculated by:
F=SpotPrice−Coupon·TtE
where TtE=DC(today, expiry)/360 stands for the day count fraction of the time to expiry under an ACT/360 convention.

18. The system of claim 15, wherein calculating an option notional for each option comprises:
assigning each option a notional
$${N}_{i} = \frac{Δ {K}_{i}}{{K}_{i}^{2}} \cdot \frac{2}{T t E} ,$$
where Kᵢ denotes the strike of the option in price terms and ΔKᵢ denotes the distance between the two neighboring strikes;
wherein
$$Δ {K}_{i} = \{ \begin{matrix}\frac{\vert {K}_{2} - {K}_{1} \vert}{2} at the center strike ( i = 1 ) , \\ \frac{\vert {K}_{i + 1} - {K}_{i - 1} \vert}{2} in between ( 1 < i < n ) , \\ \vert {K}_{n} - {K}_{n - 1} \vert at the last strike ( i = n ) .\end{matrix}$$

19-20. (canceled)
